(19) United States
(12) Patent Application Publication
(10) Pub. No.: US 2026/0332043 A1
(43) Pub. Date: Oct. 22, 2026

(54) VOLTAGE CONVERTER AND CONTROL METHOD

(71) Applicant: Panasonic Intellectual Property Management Co., Ltd., Osaka (JP)

(72) Inventors: Takeya OKUNO, Nara (JP); Shinji UJITA, Osaka (JP); Kenichiro TANAKA, Hyogo (JP); Ryusuke KANOMATA, Osaka (JP)

(21) Appl. No.: 19/158,353

(22) PCT Filed: Dec. 5, 2023
(86) PCT No.: PCT/JP2023/043424

§ 371 Date: Aug. 20, 2025

(30) Foreign Application Priority Data
Mar. 1, 2023 (JP) 2023-030856

(51) Int. Cl. H02M 3/00; H02M 1/00; H02M 1/08; H02M 3/335

(52) U.S. Cl. CPC H02M 3/01; H02M 1/0009; H02M 1/0025; H02M 1/08; H02M 3/33573; H02M 3/33592

(57) ABSTRACT

A voltage converter including: a first set of switching devices including first and second switches; a second set of switching devices including third and fourth switches; a capacitor; a transformer; a detection circuit detecting an input voltage, an input current, an output voltage, and an output current; and a control circuit. The control circuit has first and second control modes for controlling the phase and the operating frequency, and, in the first control mode, changes the phase in a predetermined cycle towards a phase target value determined in advance in accordance with the input voltage detected, a target output voltage, and a target output current; and in the second control mode, changes the operating frequency at least once during a period from when the phase is changed to when the phase is changed next time, to cause the output voltage detected to be the target output voltage.

### TECHNICAL FIELD

The present disclosure relates to a voltage converter and a control method for controlling the voltage converter.

### BACKGROUND ART

Patent Literature (PTL) 1 discloses a technique for adjusting the output voltage of a converter circuit to a value within an acceptable operating range, even when the output voltage is not within the acceptable operating range and the operating frequency is above the maximum rated frequency. More specifically, the technique disclosed in PTL 1 adjusts the output voltage by changing only the operating frequency first, and when the output voltage has not reached the target value at the maximum frequency, then adjusts the output voltage to a value within the acceptable operating range by changing the phase.

### CITATION LIST

### Patent Literature

[PTL 1] Japanese Unexamined Patent Application Publication No. 2016-63745

### SUMMARY OF INVENTION

There is an infinite number of combinations of operating frequency and phase for achieving a certain target voltage (target gain). Depending on the combination, however, a specific indicator during voltage conversion such as efficiency can be better or worse. The technique disclosed in PTL 1 fails to take into account such specific indicator, and is not necessarily capable of improving a specific indicator.

In view of the above, the present disclosure provides a voltage converter and so forth capable of improving a specific indicator during voltage conversion.

A voltage converter according to the present disclosure is a voltage converter including: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; a detection circuit that detects an input voltage applied between the first input terminal and the second input terminal, an input current inputted to the first input terminal, an output voltage applied between the first output terminal and the second output terminal, and an output current outputted from the first output terminal; and a control circuit, wherein the control circuit has: a first control mode for controlling a phase between switching of the first set of switching devices and switching of the second set of switching devices; and a second control mode for controlling an operating frequency of the first set of switching devices and the second set of switching devices, and the control circuit: in the first control mode, changes the phase in a predetermined cycle towards a phase target value that is determined in advance in accordance with the input voltage detected, a target output voltage for the output voltage, and a target output current for the output current; and in the second control mode, changes the operating frequency at least once during a period from when the phase is changed to when the phase is changed next time, to cause the output voltage detected to be the target output voltage.

A control method according to the present disclosure is a control method for controlling a voltage converter, wherein the voltage converter includes: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; and a detection circuit that detects an input voltage applied between the first input terminal and the second input terminal, an input current inputted to the first input terminal, an output voltage applied between the first output terminal and the second output terminal, and an output current outputted from the first output terminal, the control method including: controlling a phase between switching of the first set of switching devices and switching of the second set of switching devices; and controlling an operating frequency of the first set of switching devices and the second set of switching devices, wherein the controlling of the phase includes changing the phase in a predetermined cycle towards a phase target value that is determined in advance in accordance with the input voltage detected, a target output voltage for the output voltage, and a target output current for the output current, and the controlling of the operating frequency includes changing the operating frequency at least once during a period from when the phase is changed to when the phase is changed next time, to cause the output voltage detected to be the target output voltage.

A voltage converter according to the present disclosure is a voltage converter including: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; a detection circuit that detects an input voltage applied between the first input terminal and the second input terminal, an input current inputted to the first input terminal, an output voltage applied between the first output terminal and the second output terminal, and an output current outputted from the first output terminal; and a control circuit, wherein the control circuit: changes: a phase between switching of the first set of switching devices and switching of the second set of switching devices; and an operating frequency of the first set of switching devices and the second set of switching devices to a phase reference value and an operating frequency reference value that are determined in advance in accordance with the input voltage detected, a target output voltage for the output voltage, and a target output current for the output current; obtains a first indicator that is calculated from the input voltage, the input current, the output voltage, or the output current that is detected when the phase and the operating frequency are changed to the phase reference value and the operating frequency reference value; retains, as reference values, the phase reference value, the operating frequency reference value, and the first indicator; (i) changes the phase from the phase reference value by a certain amount after changing the phase and the operating frequency to the phase reference value and the operating frequency reference value; (ii) changes the operating frequency after changing the phase from the phase reference value by the certain amount to cause the output voltage detected to be the target output voltage; (iii) obtains a second indicator that is calculated from the input voltage, the input current, the output voltage, or the output current that is detected when the output voltage detected becomes the target output voltage; (iv) updates the reference values in accordance with a result of comparing the first indicator and the second indicator; and repeatedly performs each of processes from (i) to (iv).

A control method according to the present disclosure is a control method for controlling a voltage converter, wherein the voltage converter includes: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; and a detection circuit that detects an input voltage applied between the first input terminal and the second input terminal, an input current inputted to the first input terminal, an output voltage applied between the first output terminal and the second output terminal, and an output current outputted from the first output terminal, the control method including: changing: a phase between switching of the first set of switching devices and switching of the second set of switching devices; and an operating frequency of the first set of switching devices and the second set of switching devices to a phase reference value and an operating frequency reference value that are determined in advance in accordance with the input voltage detected, a target output voltage for the output voltage, and a target output current for the output current; obtaining a first indicator that is calculated from the input voltage, the input current, the output voltage, or the output current that is detected when the phase and the operating frequency are changed to the phase reference value and the operating frequency reference value; retaining, as reference values, the phase reference value, the operating frequency reference value, and the first indicator; (i) changing the phase from the phase reference value by a certain amount after the changing of the phase and the operating frequency to the phase reference value and the operating frequency reference value; (ii) changing the operating frequency after the changing of the phase from the phase reference value by the certain amount to cause the output voltage detected to be the target output voltage; (iii) obtaining a second indicator that is calculated from the input voltage, the input current, the output voltage, or the output current that is detected when the output voltage detected becomes the target output voltage; (iv) updating the reference values in accordance with a result of comparing the first indicator and the second indicator; and repeatedly performing each of processes from (i) to (iv).

A voltage converter according to the present disclosure is a voltage converter including: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; a detection circuit that detects an input voltage applied between the first input terminal and the second input terminal, an input current inputted to the first input terminal, an output voltage applied between the first output terminal and the second output terminal, and an output current outputted from the first output terminal; a memory that stores a data table in which a combination of the input voltage, the input current, the output voltage, and the output current and a combination of a phase target value and an operating frequency target value are associated for each target output voltage for the output voltage; and a control circuit, wherein the control circuit changes: a phase between switching of the first set of switching devices and switching of the second set of switching devices; and an operating frequency of the first set of switching devices and the second set of switching devices to the phase target value and the operating frequency target value that are obtained by comparing, with the data table, the input voltage, the input current, the output voltage, and the output current that have been detected.

A control method according to the present disclosure is a control method for controlling a voltage converter, wherein the voltage converter includes: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; a detection circuit that detects an input voltage applied between the first input terminal and the second input terminal, an input current inputted to the first input terminal, an output voltage applied between the first output terminal and the second output terminal, and an output current outputted from the first output terminal; and a memory that stores a data table in which a combination of the input voltage, the input current, the output voltage, and the output current and a combination of a phase target value and an operating frequency target value are associated for each target output voltage for the output voltage, the control method including: obtaining the input voltage, the input current, the output voltage, and the output current that have been detected; and changing: a phase between switching of the first set of switching devices and switching of the second set of switching devices; and an operating frequency of the first set of switching devices and the second set of switching devices to the phase target value and the operating frequency target value that are obtained by comparing, with the data table, the input voltage, the input current, the output voltage, and the output current that have been detected.

Note that these general and specific aspects may be implemented using a system, a method, an integrated circuit, a computer program, or a computer-readable recording medium such as a CD-ROM, or any combination of systems, methods, integrated circuits, computer programs, or recording media.

With the voltage converter and so forth according to an aspect of the present disclosure, it is possible to improve a specific indicator during voltage conversion.

### DESCRIPTION OF DRAWINGS

FIG. 1 is a configuration diagram showing an example of a voltage converter according to an embodiment.

FIG. 2 is a graph showing an example of the relationship between the gain and the operating frequency of the voltage converter according to the embodiment.

FIG. 3 is a flowchart showing Example Operation 1 performed by the voltage converter according to the embodiment.

FIG. 4 is a flowchart showing Example Operation 2 performed by the voltage converter according to the embodiment.

FIG. 5 is a flowchart showing Example Operation 3 performed by the voltage converter according to the embodiment.

### DESCRIPTION OF EMBODIMENT

Hereinafter, a certain exemplary embodiment is described in greater detail with reference to the accompanying Drawings.

The exemplary embodiment described below shows a general or specific example. The numerical values, shapes, materials, elements, the arrangement and connection of the elements, steps, the processing order of the steps etc. shown in the following exemplary embodiment are mere examples, and therefore do not limit the scope of the present disclosure.

### Embodiment The following describes a voltage converter according to an embodiment.

Voltage converter 1 is a DC-DC converter that increases or decreases the input voltage to a predetermined voltage and outputs the resulting voltage. Voltage converter 1 is, more specifically, an LLC converter, which is a circuit utilizing LLC resonance caused by the leakage inductance and the excitation inductance of transformer T1, and a resonant capacitor. In the LLC converter, the input/output voltage ratio (gain) changes by changing the switching frequency (also referred to as “operating frequency”). This enables the LLC converter to output a desired voltage. Since the gain can be calculated by (output voltage/input voltage)×(transformer turns ratio), there is a correlation between the gain and the output voltage.

Voltage converter 1 includes terminals t1, t2, t3, and t4. Terminal t1, which is an example of the first input terminal, is the input terminal on the primary side of voltage converter 1. Terminal t2, which is an example of the second input terminal, is the ground terminal on the primary side of voltage converter 1. Terminal t3, which is an example of the first output terminal, is the output terminal on the secondary side of voltage converter 1. Terminal t4, which is an example of the second output terminal, is the ground terminal on the secondary side of voltage converter 1. Terminals t3 and t4 are connected, for example, to the secondary winding of transformer T1 via rectifier circuit D10.

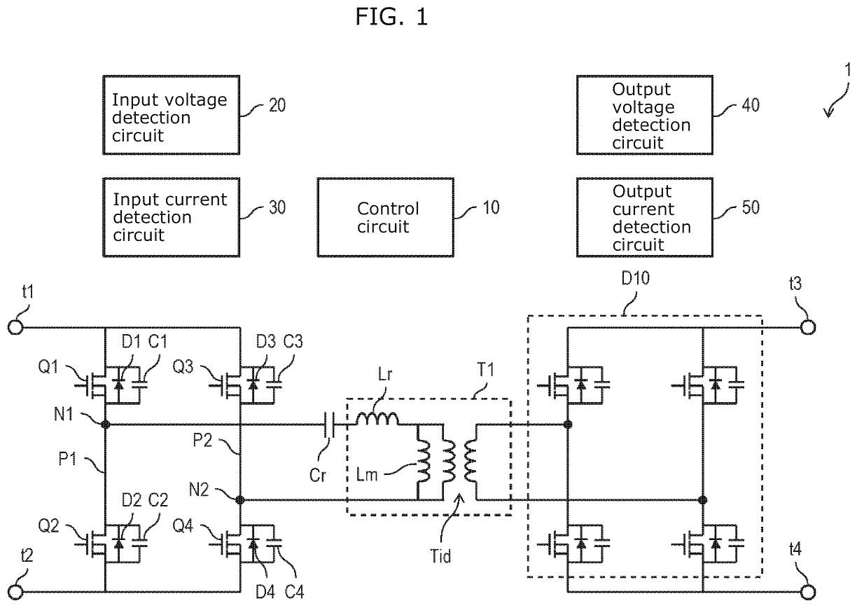

Voltage converter 1 includes switches Q1, Q2, Q3, and Q4, capacitor Cr, rectifier circuit D10, transformer T1, control circuit 10, input voltage detection circuit 20, input current detection circuit 30, output voltage detection circuit 40, and output current detection circuit 50. Note that control circuit 10, input voltage detection circuit 20, input current detection circuit 30, output voltage detection circuit 40, and output current detection circuit 50 can be realized, for example, in the form of a microcontroller, but these circuits are not limited to being realized in a specified manner; these circuits may be realized, for example, in the form of an analog circuit. FIG. 1 omits the illustration of the circuit diagrams of control circuit 10, input voltage detection circuit 20, input current detection circuit 30, output voltage detection circuit 40, and output current detection circuit 50. FIG. 1 also omits the illustration of the signal lines connecting each of control circuit 10, input voltage detection circuit 20, input current detection circuit 30, output voltage detection circuit 40, and output current detection circuit 50 to other elements.

Switches Q1 and Q2 are an example of the first set of switching devices including the first switch and the second switch that are connected in series on path P1 which connects terminal t1 and terminal t2. Path P1 is an example of the first path. In the following, switches Q1 and Q2 are also referred to as “the first set of switching devices”.

Switch Q1 is, for example, an N-channel Metal Oxide Semiconductor Field Effect Transistor (MOSFET). In FIG. 1, the parasitic capacity of switch Q1 is represented by capacitor C1, and capacitor C1 is connected in parallel with switch Q1 in the equivalent circuit. The drain of switch Q1 is connected to terminal t1, and the source of switch Q1 is connected to the drain of switch Q2. Also in FIG. 1, the parasitic diode of switch Q1 is represented by diode D1, and the anode of diode D1 is connected to the source of switch Q1 and the cathode of diode D1 is connected to the drain of switch Q1 in the equivalent circuit.

Switch Q2 is, for example, an N-channel MOSFET. In FIG. 1, the parasitic capacity of switch Q2 is represented by capacitor C2, and capacitor C2 is connected in parallel with switch Q2 in the equivalent circuit. The drain of switch Q2 is connected to the source of switch Q1, and the source of switch Q2 is connected to terminal t2. Also in FIG. 1, the parasitic diode of switch Q2 is represented by diode D2, and the anode of diode D2 is connected to the source of switch Q2 and the cathode of diode D2 is connected to the drain of switch Q2 in the equivalent circuit.

Switches Q3 and Q4 are an example of the second set of switching devices including the third switch and the fourth switch that are connected in series on path P2 which connects terminal t1 and terminal t2 and is different from path P1. Path P2 is an example of the second path. In the following, switches Q3 and Q4 are also referred to as “the second set of switching devices”.

Switch Q3 is, for example, an N-channel MOSFET. In FIG. 1, the parasitic capacity of switch Q3 is represented by capacitor C3, and capacitor C3 is connected in parallel with switch Q3 in the equivalent circuit. The drain of switch Q3 is connected to terminal t1, and the source of switch Q3 is connected to the drain of switch Q4. Also in FIG. 1, the parasitic diode of switch Q3 is represented by diode D3, and the anode of diode D3 is connected to the source of switch Q3 and the cathode of diode D3 is connected to the drain of switch Q3 in the equivalent circuit.

Switch Q4 is, for example, an N-channel MOSFET. In FIG. 1, the parasitic capacity of switch Q4 is represented by capacitor C4, and capacitor C4 is connected in parallel with switch Q4 in the equivalent circuit. The drain of switch Q4 is connected to the source of switch Q3, and the source of switch Q4 is connected to terminal t2. Also in FIG. 1, the parasitic diode of switch Q4 is represented by diode D4, and the anode of diode D4 is connected to the source of switch Q4, and the cathode of diode D4 is connected to the drain of switch Q4 in the equivalent circuit.

Capacitor Cr is an example of the resonant capacitor connected between node N1, which is located between switch Q1 and switch Q2 on path P1, and node N2, which is located between switch Q3 and switch Q4 on path P2. Node N1 is an example of the first node, and node N2 is an example of the second node.

Transformer T1 includes a primary winding and a secondary winding. One end of the primary winding is connected to capacitor Cr, the remaining end of the primary winding is connected to node N2, and the secondary winding is connected to terminals t3 and t4. More specifically, the secondary winding is connected to terminals t3 and t4 via rectifier circuit D10. FIG. 1 shows the equivalent circuit of transformer T1, where transformer T1 can be represented by ideal transformer Tid, excitation inductance Lm, and leakage inductance Lr. Excitation inductance Lm is connected in parallel with the primary coil of ideal transformer Tid, and leakage inductance Lr is connected in series with the primary coil of ideal transformer Tid. Note that voltage converter 1 may include an inductor equivalent to leakage inductance Lr and an inductor equivalent to excitation inductance Lm.

Input voltage detection circuit 20 detects the voltage inputted to voltage converter 1. More specifically, input voltage detection circuit 20 detects the input voltage applied between terminal t1 and terminal t2. Input current detection circuit 30 detects the current inputted to voltage converter 1. More specifically, input current detection circuit 30 detects the input current inputted to terminal t1. Output voltage detection circuit 40 detects the voltage outputted from voltage converter 1. More specifically, output voltage detection circuit 40 detects the output voltage applied between terminal t3 and terminal t4. Output current detection circuit 50 detects the current outputted from voltage converter 1. More specifically, output current detection circuit 50 detects the output current outputted from terminal t3. The input voltage, input current, output voltage, and output current that have been detected are notified to control circuit 10.

Input voltage detection circuit 20, input current detection circuit 30, output voltage detection circuit 40, and output current detection circuit 50 are examples of the detection circuit.

Control circuit 10 is a circuit for controlling the output voltage (or gain) of voltage converter 1 by controlling the switching (ON and OFF) of the switches (e.g., switches Q1, Q2, Q3, and Q4) included in voltage converter 1. Control circuit 10 controls the switching of switches Q1, Q2, Q3, and Q4, for example, by controlling a gate drive circuit connected to the gates of switches Q1, Q2, Q3, and Q4. More specifically, control circuit 10 controls the output voltage (or gain) of voltage converter 1 by controlling the phase between the switching of the first set of switching devices and the switching of the second set of switching devices, and also by controlling the operating frequency of the first set of switching devices and the second set of switching devices. The details of the operation performed by control circuit 10 are described later.

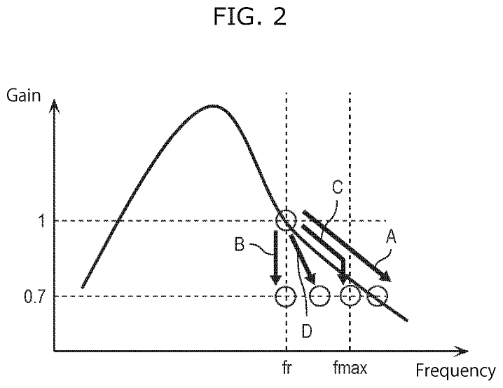

Here, with reference to FIG. 2, methods are described for bringing the output voltage of voltage converter 1 to the target output voltage, or in other words, for bringing the gain of voltage converter 1 to the target gain.

FIG. 2 is a graph showing an example of the relationship between the gain and the operating frequency. FIG. 2 shows an example of the gain characteristics of voltage converter 1, where the horizontal axis represents the operating frequency and the vertical axis represents the gain. Note that fr represents the operating frequency when the gain is 1, and fmax represents the maximum frequency at which voltage converter 1 can operate. The following describes control methods for voltage converter 1 in an example case where the current gain is 1 and the target gain is 0.7.

Example methods of changing the gain include a method of changing the operating frequency of the switches of voltage converter 1. By changing the operating frequency as indicated by arrow A in FIG. 2, it is possible to change the gain from 1 to 0.7. However, the number of switching operations per unit time increases with an increase of the operating frequency. This results in an increase in loss, and in a decrease in the efficiency in some cases. The efficiency can be calculated by (output voltage×output current)/(input voltage×input current). Note that voltage converter 1 has the maximum frequency at which voltage converter 1 can operate, and thus the operating frequency cannot be controlled beyond the maximum frequency. For this reason, it is not possible, in some cases, to bring the gain to the target gain simply by changing the operating frequency.

Example methods of changing the gain also include a method of changing the phase of the switching between the switches of voltage converter 1. By changing the phase as indicated by arrow B in FIG. 2, it is possible to change the gain from 1 to 0.7 without changing the operating frequency. However, since it is difficult to adjust the current in the case of changing the phase, a large current can flow at turn-off of the switches. This can increase the turn-off loss, resulting in a decrease in efficiency.

Example methods of changing the gain also include the method described in PTL 1. As described above, such method adjusts the output voltage by changing only the operating frequency first, and when the output voltage has not reached the target value at the maximum frequency, then adjusts the output voltage to a value within the acceptable operating range by changing the phase. With this, it is possible to change the gain from 1 to 0.7 as indicated by arrow C in FIG. 2. However, since the phase is changed after increasing the operating frequency to the maximum frequency, the efficiency can be decreased.

In view of this, control circuit 10 brings the gain to the target gain (in other words, brings the output voltage to the target output voltage) by changing the phase and the operating frequency to a combination of phase and operating frequency that improves a specific indicator during voltage conversion such as efficiency, as indicated by arrow D in FIG. 2, from among an infinite number of combinations of phase and operating frequency. The following description recites Example Operation 1 to Example Operation 3 as examples of the operation performed by control circuit 10 capable of improving a specific indicator during voltage conversion.

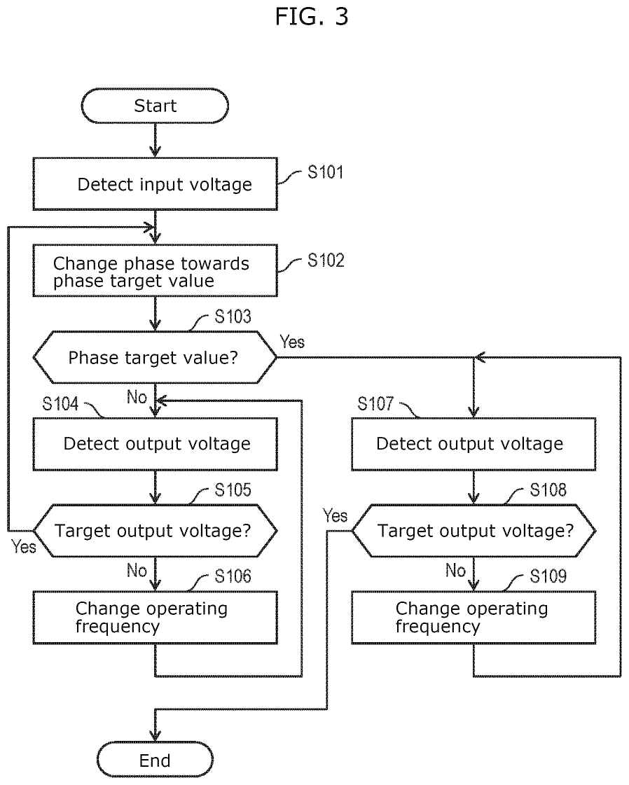

First, Example Operation 1 is described with reference to FIG. 3.

FIG. 3 is a flowchart showing Example Operation 1 performed by voltage converter 1 (control circuit 10) according to the embodiment. In Example Operation 1, for example, control circuit 10 has: a first control mode for controlling the phase between the switching of the first set of switching devices and the switching of the second set of switching devices; and a second control mode for controlling the operating frequency of the first set of switching devices and the second set of switching devices.

First, control circuit 10 detects the input voltage (step S101). More specifically, control circuit 10 obtains the input voltage detected by input voltage detection circuit 20.

Next, control circuit 10 performs control in the first control mode. More specifically, control circuit 10 performs the processes in step S102 and step S103 in the first control mode.

Control circuit 10 changes the phase between the switching of the first set of switching devices and the switching of the second set of switching devices (such phase is hereinafter simply referred to as the “phase”) towards the phase target value that is determined in advance in accordance with the detected input voltage, the target output voltage for the output voltage, and the target output current for the output current (step S102). Voltage converter 1 includes, for example, a memory that stores a data table in which a combination of input voltage, target output voltage, and target output current is associated with a phase target value. Control circuit 10 determines the phase target value using such data table, and changes the phase towards such determined phase target value. Control circuit 10 changes the phase in a predetermined cycle. More specifically, when the result in step S103 to be described later is No after performing the process in step S102, control circuit 10 performs the process in step S102 again after a certain period of time.

In such data table, for example, the phase target value that improves a specific indicator is associated with each combination of input voltage, target output voltage, and target output current. The specific indicator is, for example, efficiency, operating frequency, current that flows through the switches at turn-off, voltage applied to the switches at turn-on, output ripple voltage, or noise level. Stated differently, in such data table, the phase target value that achieves a higher efficiency, a desired operating frequency, a lower current at turn-off, a lower voltage at turn-on, a lower output ripple voltage, or a lower noise level is associated with each combination of input voltage, target output voltage, and target output current. It is possible to determine in advance the phase target value that improves the specific indicator for each combination of input voltage, target output voltage, and target output current, for example, by means of experiments or in accordance with past operation records.

As described above, in the data table, a combination of input voltage, target output voltage, and target output current and the phase target value that improve the specific indicator during voltage conversion are associated with each other. With this, it is possible to determine the phase target value that improves the specific indicator by comparing, with the data table, the detected input voltage, the target output voltage, and the target output current.

Next, control circuit 10 determines whether the phase has reached the phase target value (step S103). When the phase is significantly changed at one time, for example, the output voltage can significantly deviate from the target output voltage. This makes it difficult to perform a search, carried out in step S104 to step S106 to be described later, for the operating frequency for bringing the output voltage to the target output voltage. In view of this, the processes from step S102 to step S106 are repeatedly performed, and the phase is gradually brought closer to the phase target value in step S102 in the course of such repetition. After the determination in step S103, control circuit 10 performs control in the second control mode. More specifically, control circuit 10 performs the processes from step S104 to step S106 or the processes from step S107 to step S109 in the second control mode.

When determining that the phase has not reached the phase target value (No in step S103), control circuit 10 detects the output voltage (step S104). More specifically, control circuit 10 obtains the output voltage detected by output voltage detection circuit 40.

Next, control circuit 10 determines whether the output voltage has become the target output voltage (step S105). Since the output voltage changes in response to a change of the phase, control circuit 10 changes the operating frequency in the second control mode, for example, to bring the output voltage to the target output voltage.

When determining that the output voltage has not become the target output voltage (No in step S105), control circuit 10 changes the operating frequency to cause the detected output voltage to be the target output voltage (step S106). Since a single change of the operating frequency does not necessarily bring the output voltage to the target output voltage, the processes from step S104 to step S106 are performed at least once during the period from when the process in step S102 has been performed to when the process in step S102 is performed next time, to cause the output voltage to be the target output voltage.

When determining that the output voltage has become the target output voltage (Yes in step S105), control circuit 10 changes the phase by a certain amount towards the phase target value in step S102, and performs again the processes from step S103 onwards.

Note that control circuit 10 may also detect the output current in step S104. In this case, control circuit 10 also determines, in step S105, whether the output current has become the target output current. When the output voltage has become the target output voltage and the output current has become the target output current, control circuit 10 returns to step S102. When the output voltage has not become the target output voltage or the output current has not become the target output current, control circuit 10 proceeds to step S106.

When determining that the phase has reached the phase target value (Yes in step S103), control circuit 10 performs the processes from step S107 to step S109 that are basically the same as the processes from step S104 to step S106. More specifically, step S107 corresponds to step S104, step S108 corresponds to step S105, and step S109 corresponds to step S106. However, when control circuit 10 determines that the output voltage has become the target output voltage (Yes in step S108), the phase has already become the phase target value, meaning that the phase is not required to be changed towards the phase target value in step S102. In this case, the processing is terminated.

As described above, in the first control mode, control circuit 10 changes the phase in the predetermined cycle towards the phase target value that is determined in advance in accordance with the detected input voltage, the target output voltage for the output voltage, and the target output current for the output current. In the second control mode, control circuit 10 changes the operating frequency at least once during the period from when the phase has been changed to when the phase is changed next time to bring the detected output voltage to the target output voltage.

In Example Operation 1, the phase target value that is determined in advance in accordance with the detected input voltage, the target output voltage, and the target output current is a value that improves the specific indicator during voltage conversion. Thus, by changing the phase towards the phase target value in the first control mode, it is possible to improve the specific indicator. However, it is difficult to bring the output voltage to the target output voltage simply by changing the phase. For this reason, by changing the operating frequency at least once during the period from when the phase has been changed to when the phase is changed next time, a search is performed for the operating frequency for bringing the output voltage to the target output voltage. With this, it is possible to bring the output voltage to the target output voltage and also improve the specific indicator during voltage conversion.

Also, when the phase is significantly changed at one time, the output voltage can significantly deviate from the target output voltage, making it difficult to search for the operating frequency for bringing the output voltage to the target output voltage. In view of this, control circuit 10 repeatedly changes the phase in the first control mode and the operating frequency in the second control mode while gradually bringing the phase closer to the phase target value. As described above, by repeating the change of the phase and the change of the operating frequency after the change of the phase, while gradually bringing the phase closer to the phase target value, it becomes easier to bring the output voltage to the target output voltage.

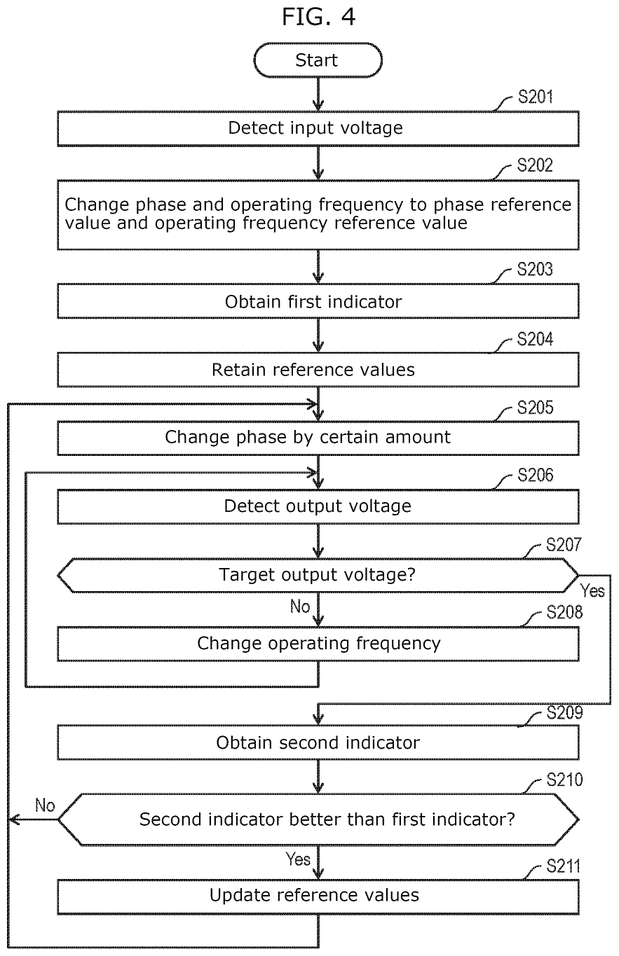

Next, Example Operation 2 is described with reference to FIG. 4.

FIG. 4 is a flowchart showing Example Operation 2 performed by voltage converter 1 (control circuit 10) according to the embodiment.

First, control circuit 10 detects the input voltage (step S201). More specifically, control circuit 10 obtains the input voltage detected by input voltage detection circuit 20.

Next, control circuit 10 changes: the phase between the switching of the first set of switching devices and the switching of the second set of switching devices (such phase is hereinafter simply referred to as the “phase”); and the operating frequency of the first set of switching devices and the second set of switching devices (such operating frequency is hereinafter simply referred to as the “operating frequency”) to the phase reference value and the operating frequency reference value that are determined in advance in accordance with the detected input voltage, the target output voltage for the output voltage, and the target output current for the output current (step S202). Voltage converter 1 includes, for example, a memory that stores a data table in which a combination of input voltage, target output voltage, and target output current is associated with a combination of phase reference value and operating frequency reference value. Control circuit 10 determines the phase reference value and the operating frequency reference value using such data table, and changes the phase and the operating frequency to such determined phase reference value and operating frequency reference value.

In such data table, for example, the phase reference value and the operating frequency reference value that improve the specific indicator are associated with each combination of input voltage, target output voltage, and target output current. The specific indicator is, for example, efficiency, operating frequency, current that flows through the switches at turn-off, voltage applied to the switches at turn-on, output ripple voltage, or noise level. Stated differently, in such data table, a combination of phase reference value and operating frequency reference value that achieves a higher efficiency, a desired operating frequency, a lower current at turn-off, a lower voltage at turn-on, a lower output ripple voltage, or a lower noise is associated with each combination of input voltage, target output voltage, and target output current. It is possible to determine in advance a combination of phase reference value and operating frequency reference value that improves the specific indicator for each combination of input voltage, target output voltage, and target output current, for example, by means of experiments or in accordance with past operation records.

As described above, in the data table, a combination of input voltage, target output voltage, and target output current is associated with a combination of phase reference value and operating frequency reference value. With this, it is possible to determine the first phase reference value and operating frequency reference value by comparing, with the data table, the detected input voltage, the target output voltage, and the target output current.

Next, control circuit 10 obtains a first indicator calculated from the input voltage, input current, output voltage, and output current that are detected when the phase and the operating frequency are changed to the phase reference value and the operating frequency reference value (step S203). As described above, the first indicator is, for example, efficiency, operating frequency, current that flows through the switches at turn-off, voltage applied to the switches at turn-on, output ripple voltage, or noise level.

Next, control circuit 10 retains, in a location such as a memory, the phase reference value, the operating frequency reference value, and the first indicator as reference values (step S204).

After changing the phase and the operating frequency to the phase reference value and the operating frequency reference value, control circuit 10 then changes the phase from the phase reference value by a certain amount (step S205). Such certain amount is not limited to a specific amount. However, when the phase is significantly changed at one time, it becomes difficult to perform a search, carried out in step S206 to step S208 to be described later, for the operating frequency for bringing the output voltage to the target output voltage. For this reason, such certain amount is set, for example, to a certain small amount.

Next, control circuit 10 detects the output voltage after changing the phase from the phase reference value by the certain amount (step S206). More specifically, control circuit 10 obtains the output voltage detected by output voltage detection circuit 40.

Next, control circuit 10 determines whether the output voltage has become the target output voltage (step S207). Since the output voltage changes in response to a change of the phase, for example, control circuit 10 changes the operating frequency to cause the output voltage to be the target output voltage.

When determining that the detected output voltage has not become the target output voltage (No in step S207), control circuit 10 changes the operating frequency to cause the detected output voltage to be the target output voltage (step S208). Since a single change of the operating frequency does not necessarily bring the output voltage to the target output voltage, the processes from step S206 to step S208 are performed at least once to cause the output voltage to be the target output voltage.

When determining that the detected output voltage has become the target output voltage (Yes in step S207), control circuit 10 obtains a second indicator calculated from the input voltage, input current, output voltage, or output current that has been detected when the detected output voltage has become the target output voltage (step S209). As described above, the second indicator is, for example, efficiency, operating frequency, current that flows through the switches at turn-off, voltage applied to the switches at turn-on, output ripple voltage, or noise level.

Note that control circuit 10 may also detect the output current in step S206. In this case, control circuit 10 also determines, in step S207, whether the output current has become the target output current. When the output voltage has become the target output voltage and the output current has become the target output current, control circuit 10 proceeds to step S209. When the output voltage has not become the target output voltage or the output current has not become the target output current, control circuit 10 proceeds to step S208.

Next, control circuit 10 compares the first indicator and the second indicator to determine whether the second indicator is better than the first indicator (step S210). When each of the first indicator and the second indicator is efficiency, for example, control circuit 10 determines whether the efficiency when the phase is changed from the phase reference value by the certain amount and then the operating frequency is changed is better than the efficiency when the phase and the operating frequency are changed to the phase reference value and the operating frequency reference value.

When the second indicator is better than the first indicator (Yes in step S210), control circuit 10 updates the reference values (step S211). More specifically, the value of the first indicator in the retained reference values is updated to the value of the second indicator, the value of the phase reference value in the retained reference values is updated to the value of the phase that has been changed, and the value of the operating frequency reference value in the retained reference values is updated to the value of the operating frequency that has been changed. Control circuit 10 then performs again the processes from step S205 onwards using the updated reference values.

When the second indicator is worse than the first indicator or these indicators are the same (No in step S210), control circuit 10 changes, in step S205, the phase from the phase reference value by an amount different from the previous amount, and performs again the processes from step S206 onwards.

As described above, control circuit 10 (i) changes the phase from the phase reference value by the certain amount after changing the phase and the operating frequency to the phase reference value and the operating frequency reference value, (ii) changes the operating frequency after changing the phase from the phase reference value by the certain amount to bring the detected output voltage to the target output voltage, (iii) obtains the second indicator calculated from the input voltage, input current, output voltage, or output current that is detected when the detected output voltage has become the target output voltage, and (iv) updates the reference values in accordance with the result of comparing the first indicator and the second indicator, and repeats each of the processes from (i) to (iv).

In Example Operation 2, when the second indicator, which serves as the specific indicator when the phase and the operating frequency are changed from the state of serving as the reference values (the phase reference value and the operating frequency reference value for when the first indicator serves as the specific indicator during voltage conversion) is better than the first indicator, the reference values (the first indicator, the phase reference value, and the operating frequency reference value) are updated to the second indicator, and the phase and the operating frequency that have been changed. The phase and the operating frequency are then changed again from the state of serving as the updated reference values (i.e., the previous phase and operating frequency when the second indicator becomes the specific indicator). The repetition of this improves the specific indicator. It is thus possible to improve the specific indicator during voltage conversion.

For example, control circuit 10 may perform Proportional Integral (PI) control of the phase and the operating frequency in accordance with the result of comparing the first indicator and the second indicator. More specifically, when the second indicator better than the first indicator serving as the current reference value cannot be found even after the processes from step S205 to step S210 are repeated for a plurality of times, the PI control of the phase and the operating frequency may be performed to maintain the current first indicator, assuming that such indicator is the optimal indicator. Also, when the second indicator better than the first indicator serving as the current reference value cannot be found even after the processes from step S205 to step S210 are repeated for a plurality of times, a more optimal indicator may be searched for by changing the phase by a smaller amount than the previous time with respect to the current phase reference value.

Note that control circuit 10 may skip performing the process of (ii), when the detected output voltage has become the target output voltage after the phase is changed from the phase reference value by the certain amount in the process of (i). As described above, when the output voltage becomes the target output voltage simply by changing the phase, it is not necessary to change the operating frequency.

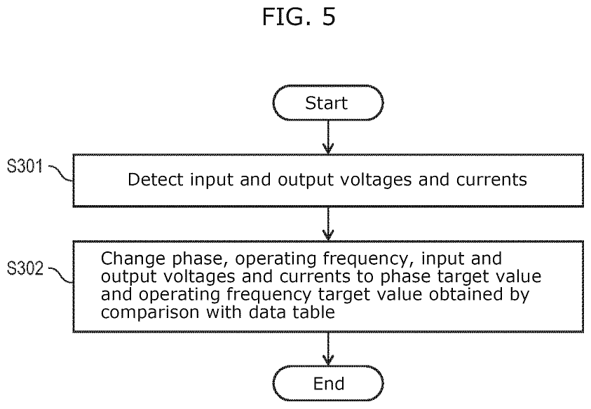

Next, Example Operation 3 is described with reference to FIG. 5.

FIG. 5 is a flowchart showing Example Operation 3 performed by voltage converter 1 (control circuit 10) according to the embodiment. Example Operation 3 assumes that voltage converter 1 includes a memory that stores a data table in which a combination of input voltage, input current, output voltage, and output current and a combination of phase target value and operating frequency target value are associated for each target output voltage for the output voltage.

First, control circuit 10 detects the input voltage, the input current, the output voltage, and the output current (step S301). More specifically, control circuit 10 obtains the input voltage detected by input voltage detection circuit 20, the input current detected by input current detection circuit 30, the output voltage detected by output voltage detection circuit 40, and the output current detected by output current detection circuit 50.

Control circuit 10 then changes: the phase between the switching of the first set of switching devices and the switching of the second set of switching devices (such phase is hereinafter simply referred to as the “phase”); and the operating frequency of the first set of switching devices and the second set of switching devices (such operating frequency is hereinafter simply referred to as the “operating frequency”) to the phase target value and the operating frequency target value that are obtained by comparing, with the data table, the input voltage, input current, output voltage, and output current that have been detected (step S302).

In such data table, for example, the phase target value and the operating frequency target value that improve the specific indicator are associated for each combination of input voltage, input current, output voltage, and output current. This relationship is present for each target output voltage. The specific indicator is, for example, efficiency, operating frequency, current that flows through the switches at turn-off, voltage applied to the switches at turn-on, output ripple voltage, or noise level. Stated differently, in such data table, a combination of phase target value and operating frequency target value that achieves a higher efficiency, a desired operating frequency, a lower current at turn-off, a lower voltage at turn-on, a lower output ripple voltage, or a lower noise is associated with each combination of input voltage, input current, output voltage, and output current and target output voltage. It is possible to determine in advance a combination of phase target value and operating frequency target value that improves the specific indicator for each combination of input voltage, input current, output voltage, and output current and target output voltage, for example, by means of experiments or in accordance with past operation records.

As described above, in the data table, a combination of input voltage, input current, output voltage, and output current and a combination of phase target value and operating frequency target value that improve the specific indicator during voltage conversion are associated for each target output voltage. With this, it is possible to determine the phase target value and the operating frequency target value that improve the specific indicator by comparing, with the data table, the input voltage, input current, output voltage, and output current that have been detected, and the target output voltage. It is thus possible to improve the specific indicator during voltage conversion by changing the phase and the operating frequency to the determined phase target value and operating frequency target value.

### Other Embodiments

As described above, the embodiment has been described above to show an example of the technique according to the present disclosure. However, the technique according to the present disclosure is not limited to this, and also applicable to an embodiment to which, for example, modification, replacement, addition, omission, etc. are applied as appropriate. For example, variations as described below are also included in an embodiment of the present disclosure.

In Example Operation 1 in the foregoing embodiment, for example, an example has been described where control circuit 10 repeatedly changes the phase in the first control mode and the operating frequency in the second control mode, while gradually bringing the phase closer to the phase target value, but the present disclosure is not limited this. For example, control circuit 10 may not gradually change the phase towards the phase target value, but may directly change the phase to the phase target value. Stated differently, the processes from step S104 to step S106 in FIG. 3 may not be performed.

Also, the present disclosure can be realized not only in the form of voltage converter 1, for example, but also in the form of a control method for controlling voltage converter 1 that includes the steps (processes) performed by an element (more specifically, control circuit 10) included in voltage converter 1.

The control method corresponding to Example Operation 1 described above is a control method for controlling voltage converter 1. Such voltage converter 1 includes: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; and a detection circuit that detects an input voltage applied between the first input terminal and the second input terminal, an input current inputted to the first input terminal, an output voltage applied between the first output terminal and the second output terminal, and an output current outputted from the first output terminal. As shown in FIG. 3, the control method includes: controlling a phase between switching of the first set of switching devices and switching of the second set of switching devices; and controlling an operating frequency of the first set of switching devices and the second set of switching devices, wherein the controlling of the phase includes changing the phase in a predetermined cycle towards a phase target value that is determined in advance in accordance with the input voltage detected, a target output voltage for the output voltage, and a target output current for the output current (step S102), and the controlling of the operating frequency includes changing the operating frequency at least once during a period from when the phase is changed to when the phase is changed next time, to cause the output voltage detected to be the target output voltage (step S106).

The control method corresponding to Example Operation 2 described above is a control method for controlling voltage converter 1. Such voltage converter 1 includes: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; and a detection circuit that detects an input voltage applied between the first input terminal and the second input terminal, an input current inputted to the first input terminal, an output voltage applied between the first output terminal and the second output terminal, and an output current outputted from the first output terminal. As shown in FIG. 4, the control method includes: changing: a phase between switching of the first set of switching devices and switching of the second set of switching devices; and an operating frequency of the first set of switching devices and the second set of switching devices to a phase reference value and an operating frequency reference value that are determined in advance in accordance with the input voltage detected, a target output voltage for the output voltage, and a target output current for the output current (step S202); obtaining a first indicator that is calculated from the input voltage, the input current, the output voltage, or the output current that is detected when the phase and the operating frequency are changed to the phase reference value and the operating frequency reference value (step S203); retaining, as reference values, the phase reference value, the operating frequency reference value, and the first indicator (step S204); (i) changing the phase from the phase reference value by a certain amount after the changing of the phase and the operating frequency to the phase reference value and the operating frequency reference value (step S205); (ii) changing the operating frequency after the changing of the phase from the phase reference value by the certain amount to cause the output voltage detected to be the target output voltage (step S208); (iii) obtaining a second indicator that is calculated from the input voltage, the input current, the output voltage, or the output current that is detected when the output voltage detected becomes the target output voltage (step S209); (iv) updating the reference values in accordance with a result of comparing the first indicator and the second indicator (step S211); and repeatedly performing each of processes from (i) to (iv).

The control method corresponding to Example Operation 3 described above is a control method for controlling voltage converter 1. Such voltage converter 1 includes: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; a detection circuit that detects an input voltage applied between the first input terminal and the second input terminal, an input current inputted to the first input terminal, an output voltage applied between the first output terminal and the second output terminal, and an output current outputted from the first output terminal; and a memory that stores a data table in which a combination of the input voltage, the input current, the output voltage, and the output current and a combination of a phase target value and an operating frequency target value are associated for each target output voltage for the output voltage. As shown in FIG. 5, the control method includes: obtaining the input voltage, the input current, the output voltage, and the output current that have been detected; and changing: a phase between switching of the first set of switching devices and switching of the second set of switching devices; and an operating frequency of the first set of switching devices and the second set of switching devices to the phase target value and the operating frequency target value that are obtained by comparing, with the data table, the input voltage, the input current, the output voltage, and the output current that have been detected (step S302).

The present disclosure can be realized, for example, in the form of a program for causing a computer (processor) to execute the steps included in the control method. Further, the present disclosure can be realized in the form of a non-transitory, computer-readable recording medium such as a CD-ROM having recorded thereon such program.

When the present disclosure is realized in the form of a program (software), the steps are executed by means of the program being executed using hardware resources of the computer, such as a CPU, a memory, and an input-output circuit. Stated differently, the steps are executed by mans of the CPU obtaining data from, for example, the memory or the input-output circuit to perform calculations, and outputting calculation results to, for example, the memory or the input-output circuit.

Each of the elements included in voltage converter 1 in the foregoing embodiment may be configured in the form of an exclusive hardware product, or may be realized by executing a software program suitable for the element. Each of the elements may be realized by means of a program executing unit, such as a CPU and a processor, reading and executing the software program recorded on a recording medium such as a hard disk or a semiconductor memory.

Note that the functions of voltage converter 1 according to the foregoing embodiment may be realized, in part or in whole, in the form of a large-scale integration (LSI), which is typically an integrated circuit. Such functions may take the form of individual chips, or may be encapsulated into a single chip in part or in whole. Also, the circuit integration is not limited to the integration into an LSI, and thus may be realized in the form of an exclusive circuit or a general-purpose processor. A field programmable gate array (FPGA) that allows for programming after the manufacture of an LSI, or a reconfigurable processor that allows for reconfiguration of the connection and the settings of circuit cells inside an LSI may be employed.

Furthermore, when a circuit integration technology that replaces LSIs becomes available as a result of the future progress in the semiconductor technology or other derivative technologies, such technology may certainly be employed to integrate the elements included in voltage converter 1 into an integrated circuit.

The scope of the present disclosure also includes an embodiment achieved by making various modifications to the embodiment that can be conceived by those skilled in the art and an embodiment achieved by freely combining elements and functions in each embodiment without departing from the essence of the present disclosure.

### Added Notes

From the above description of the embodiment, the following techniques are disclosed.

### Technique 1

A voltage converter including: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; a detection circuit that detects an input voltage applied between the first input terminal and the second input terminal, an input current inputted to the first input terminal, an output voltage applied between the first output terminal and the second output terminal, and an output current outputted from the first output terminal; and a control circuit, wherein the control circuit has: a first control mode for controlling a phase between switching of the first set of switching devices and switching of the second set of switching devices; and a second control mode for controlling an operating frequency of the first set of switching devices and the second set of switching devices, and the control circuit: in the first control mode, changes the phase in a predetermined cycle towards a phase target value that is determined in advance in accordance with the input voltage detected, a target output voltage for the output voltage, and a target output current for the output current; and in the second control mode, changes the operating frequency at least once during a period from when the phase is changed to when the phase is changed next time, to cause the output voltage detected to be the target output voltage.

The phase target value that is determined in advance in accordance with the detected input voltage, the target output voltage, and the target output current is a value that improves the specific indicator during voltage conversion. Thus, by changing the phase towards the phase target value in the first control mode, it is possible to improve the specific indicator. However, it is difficult to bring the output voltage to the target output voltage simply by changing the phase. For this reason, by changing the operating frequency at least once during the period from when the phase has been changed to when the phase is changed next time, a search is performed for the operating frequency for bringing the output voltage to the target output voltage. With this, it is possible to bring the output voltage to the target output voltage and also improve the specific indicator during voltage conversion.

### Technique 2

The voltage converter according to technique 1, wherein the voltage converter includes a memory that stores a data table in which a combination of the input voltage, the target output voltage, and the target output current is associated with the phase target value, and the control circuit determines the phase target value using the data table.

As described above, in the data table, a combination of input voltage, target output voltage, and target output current and the phase target value that improve the specific indicator during voltage conversion are associated with each other. With this, it is possible to determine the phase target value that improves the specific indicator by comparing, with the data table, the detected input voltage, the target output voltage, and the target output current.

### Technique 3

The voltage converter according to technique 1 or 2, wherein the control circuit repeatedly changes the phase in the first control mode and the operating frequency in the second control mode, while gradually bringing the phase closer to the phase target value.

When the phase is significantly changed at one time, the output voltage can significantly deviate from the target output voltage, making it difficult to search for the operating frequency for bringing the output voltage to the target output voltage. In view of this, by repeating the change of the phase and the change of the operating frequency after the change of the phase, while gradually bringing the phase closer to the phase target value, it becomes easier to bring the output voltage to the target output voltage.

### Technique 4

A control method for controlling a voltage converter, wherein the voltage converter includes: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; and a detection circuit that detects an input voltage applied between the first input terminal and the second input terminal, an input current inputted to the first input terminal, an output voltage applied between the first output terminal and the second output terminal, and an output current outputted from the first output terminal, the control method including: controlling a phase between switching of the first set of switching devices and switching of the second set of switching devices; and controlling an operating frequency of the first set of switching devices and the second set of switching devices, wherein the controlling of the phase includes changing the phase in a predetermined cycle towards a phase target value that is determined in advance in accordance with the input voltage detected, a target output voltage for the output voltage, and a target output current for the output current, and the controlling of the operating frequency includes changing the operating frequency at least once during a period from when the phase is changed to when the phase is changed next time, to cause the output voltage detected to be the target output voltage.

With this, it is possible to provide a control method capable of bringing the output voltage to the target output voltage and also improving the specific indicator during voltage conversion.

### Technique 5

A voltage converter including: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; a detection circuit that detects an input voltage applied between the first input terminal and the second input terminal, an input current inputted to the first input terminal, an output voltage applied between the first output terminal and the second output terminal, and an output current outputted from the first output terminal; and a control circuit, wherein the control circuit: changes: a phase between switching of the first set of switching devices and switching of the second set of switching devices; and an operating frequency of the first set of switching devices and the second set of switching devices to a phase reference value and an operating frequency reference value that are determined in advance in accordance with the input voltage detected, a target output voltage for the output voltage, and a target output current for the output current; obtains a first indicator that is calculated from the input voltage, the input current, the output voltage, or the output current that is detected when the phase and the operating frequency are changed to the phase reference value and the operating frequency reference value; retains, as reference values, the phase reference value, the operating frequency reference value, and the first indicator; (i) changes the phase from the phase reference value by a certain amount after changing the phase and the operating frequency to the phase reference value and the operating frequency reference value; (ii) changes the operating frequency after changing the phase from the phase reference value by the certain amount to cause the output voltage detected to be the target output voltage; (iii) obtains a second indicator that is calculated from the input voltage, the input current, the output voltage, or the output current that is detected when the output voltage detected becomes the target output voltage; (iv) updates the reference values in accordance with a result of comparing the first indicator and the second indicator; and repeatedly performs each of processes from (i) to (iv).

When the second indicator, which serves as the specific indicator when the phase and the operating frequency are changed from the state of serving as the reference values (the phase reference value and the operating frequency reference value for when the first indicator serves as the specific indicator during voltage conversion) is better than the first indicator, the reference values (the first indicator, the phase reference value, and the operating frequency reference value) are updated to the second indicator, and the phase and the operating frequency that have been changed. The phase and the operating frequency are then changed again from the state of serving as the updated reference values (i.e., the phase and the operating frequency for when the second indicator becomes the specific indicator last time). The repetition of this improves the specific indicator. It is thus possible to improve the specific indicator during voltage conversion.

### Technique 6

The voltage converter according to technique 5, wherein the voltage converter includes a memory that stores a data table in which a combination of the input voltage, the target output voltage, and the target output current is associated with a combination of the phase reference value and the operating frequency reference value, and the control circuit determines the phase reference value and the operating frequency reference value using the data table.

As described above, in the data table, a combination of input voltage, target output voltage, and target output current is associated with a combination of phase reference value and operating frequency reference value. With this, it is possible to determine the first phase reference value and operating frequency reference value by comparing, with the data table, the detected input voltage, the target output voltage, and the target output current.

### Technique 7

The voltage converter according to technique 5 or 6, wherein each of the first indicator and the second indicator is efficiency, operating frequency, current that flows through the first to fourth switches at turn-off, voltage applied to the first to fourth switches at turn-on, output ripple voltage, or noise level.

With this, it is possible, for example, to increase the efficiency during voltage conversion, achieve a desired operating frequency, reduce the current and voltage during turn-off, and reduce the output

### Technique 8

The voltage converter according to any one of techniques 5 to 7, wherein the control circuit performs Proportional Integral (PI) control of the phase and the operating frequency in accordance with the result of comparing the first indicator and the second indicator.

With this, it is possible to perform PI control to cause the specific indicator to be the target indicator.

### Technique 9

The voltage converter according to any one of techniques 5 to 8, wherein the control circuit skips performing the process of (ii) when the output voltage detected becomes the target output voltage after changing the phase from the phase reference value by the certain amount in the process of (i).

In some cases, for example, it is possible to bring the output voltage to the target output voltage simply by changing the phase. In this case, it is not necessary to change the operating frequency.

### Technique 10

A control method for controlling a voltage converter, wherein the voltage converter includes: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; and a detection circuit that detects an input voltage applied between the first input terminal and the second input terminal, an input current inputted to the first input terminal, an output voltage applied between the first output terminal and the second output terminal, and an output current outputted from the first output terminal, the control method including: changing: a phase between switching of the first set of switching devices and switching of the second set of switching devices; and an operating frequency of the first set of switching devices and the second set of switching devices to a phase reference value and an operating frequency reference value that are determined in advance in accordance with the input voltage detected, a target output voltage for the output voltage, and a target output current for the output current; obtaining a first indicator that is calculated from the input voltage, the input current, the output voltage, or the output current that is detected when the phase and the operating frequency are changed to the phase reference value and the operating frequency reference value; retaining, as reference values, the phase reference value, the operating frequency reference value, and the first indicator; (i) changing the phase from the phase reference value by a certain amount after the changing of the phase and the operating frequency to the phase reference value and the operating frequency reference value; (ii) changing the operating frequency after the changing of the phase from the phase reference value by the certain amount to cause the output voltage detected to be the target output voltage; (iii) obtaining a second indicator that is calculated from the input voltage, the input current, the output voltage, or the output current that is detected when the output voltage detected becomes the target output voltage; (iv) updating the reference values in accordance with a result of comparing the first indicator and the second indicator; and repeatedly performing each of processes from (i) to (iv).

With this, it is possible to provide a control method capable of improving the specific indicator during voltage conversion.

### Technique 11

A voltage converter including: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; a detection circuit that detects an input voltage applied between the first input terminal and the second input terminal, an input current inputted to the first input terminal, an output voltage applied between the first output terminal and the second output terminal, and an output current outputted from the first output terminal; a memory that stores a data table in which a combination of the input voltage, the input current, the output voltage, and the output current and a combination of a phase target value and an operating frequency target value are associated for each target output voltage for the output voltage; and a control circuit, wherein the control circuit changes: a phase between switching of the first set of switching devices and switching of the second set of switching devices; and an operating frequency of the first set of switching devices and the second set of switching devices to the phase target value and the operating frequency target value that are obtained by comparing, with the data table, the input voltage, the input current, the output voltage, and the output current that have been detected.

With this, in the data table, a combination of input voltage, input current, output voltage, and output current and a combination of phase target value and operating frequency target value that improve the specific indicator during voltage conversion are associated with each other for each target output voltage. With this, it is possible to determine the phase target value and the operating frequency target value that improve the specific indicator by comparing, with the data table, the input voltage, input current, output voltage, and output current that have been detected, and the target output voltage. It is thus possible to improve the specific indicator during voltage conversion by changing the phase and the operating frequency to the determined phase target value and operating frequency target value.

### Technique 12

A control method for controlling a voltage converter, wherein the voltage converter includes: a first set of switching devices including a first switch and a second switch connected in series on a first path connecting a first input terminal and a second input terminal; a second set of switching devices including a third switch and a fourth switch connected in series on a second path connecting the first input terminal and the second input terminal, the second path being a different path from the first path; a resonant capacitor connected between a first node located between the first switch and the second switch on the first path and a second node located between the third switch and the fourth switch on the second path; a transformer including a primary winding and a secondary winding, the primary winding including one end connected to the resonant capacitor and a remaining end connected to the second node, the secondary winding being connected to a first output terminal and a second output terminal; a detection circuit that detects an input voltage applied between the first input terminal and the second input terminal, an input current inputted to the first input terminal, an output voltage applied between the first output terminal and the second output terminal, and an output current outputted from the first output terminal; and a memory that stores a data table in which a combination of the input voltage, the input current, the output voltage, and the output current and a combination of a phase target value and an operating frequency target value are associated for each target output voltage for the output voltage, the control method including: obtaining the input voltage, the input current, the output voltage, and the output current that have been detected; and changing: a phase between switching of the first set of switching devices and switching of the second set of switching devices; and an operating frequency of the first set of switching devices and the second set of switching devices to the phase target value and the operating frequency target value that are obtained by comparing, with the data table, the input voltage, the input current, the output voltage, and the output current that have been detected.

With this, it is possible to provide a control method capable of improving the specific indicator during voltage conversion.

### Industrial Applicability

The present disclosure is applicable for use as, for example, a voltage converter such as an LLC converter.

### REFERENCE SIGNS LIST

1 voltage converter
10 control circuit
20 input voltage detection circuit
30 input current detection circuit
40 output voltage detection circuit
50 output current detection circuit
C1, C2, C3, C4, Cr capacitor
D1, D2, D3, D4 diode
D10 rectifier circuit
Lm excitation inductance
Lr leakage inductance
N1, N2 node
P1, P2 path
Q1, Q2, Q3, Q4 switch
T1 transformer
Tid ideal transformer
t1, t2, t3, t4 terminal

1. A voltage converter comprising:
a first set of switching devices including a first switch and a second switch connected in series on a first path connecting a first input terminal and a second input terminal;
a second set of switching devices including a third switch and a fourth switch connected in series on a second path connecting the first input terminal and the second input terminal, the second path being a different path from the first path;
a resonant capacitor connected between a first node located between the first switch and the second switch on the first path and a second node located between the third switch and the fourth switch on the second path;
a transformer including a primary winding and a secondary winding, the primary winding including one end connected to the resonant capacitor and a remaining end connected to the second node, the secondary winding being connected to a first output terminal and a second output terminal;
a detection circuit that detects an input voltage applied between the first input terminal and the second input terminal, an input current inputted to the first input terminal, an output voltage applied between the first output terminal and the second output terminal, and an output current outputted from the first output terminal; and
a control circuit,
wherein the control circuit has:
a first control mode for controlling a phase between switching of the first set of switching devices and switching of the second set of switching devices; and
a second control mode for controlling an operating frequency of the first set of switching devices and the second set of switching devices, and
the control circuit:
in the first control mode, changes the phase in a predetermined cycle towards a phase target value that is determined in advance in accordance with the input voltage detected, a target output voltage for the output voltage, and a target output current for the output current; and
in the second control mode, changes the operating frequency at least once during a period from when the phase is changed to when the phase is changed next time, to cause the output voltage detected to be the target output voltage.

2. The voltage converter according to claim 1,
wherein the voltage converter comprises a memory that stores a data table in which a combination of the input voltage, the target output voltage, and the target output current is associated with the phase target value, and
the control circuit determines the phase target value using the data table.

3. The voltage converter according to claim 1,
wherein the control circuit repeatedly changes the phase in the first control mode and the operating frequency in the second control mode, while gradually bringing the phase closer to the phase target value.

4. A control method for controlling a voltage converter,
wherein the voltage converter includes:
a first set of switching devices including a first switch and a second switch connected in series on a first path connecting a first input terminal and a second input terminal;
a second set of switching devices including a third switch and a fourth switch connected in series on a second path connecting the first input terminal and the second input terminal, the second path being a different path from the first path;
a resonant capacitor connected between a first node located between the first switch and the second switch on the first path and a second node located between the third switch and the fourth switch on the second path;
a transformer including a primary winding and a secondary winding, the primary winding including one end connected to the resonant capacitor and a remaining end connected to the second node, the secondary winding being connected to a first output terminal and a second output terminal; and
a detection circuit that detects an input voltage applied between the first input terminal and the second input terminal, an input current inputted to the first input terminal, an output voltage applied between the first output terminal and the second output terminal, and an output current outputted from the first output terminal,
the control method comprising:
controlling a phase between switching of the first set of switching devices and switching of the second set of switching devices; and
controlling an operating frequency of the first set of switching devices and the second set of switching devices,
wherein the controlling of the phase includes changing the phase in a predetermined cycle towards a phase target value that is determined in advance in accordance with the input voltage detected, a target output voltage for the output voltage, and a target output current for the output current, and
the controlling of the operating frequency includes changing the operating frequency at least once during a period from when the phase is changed to when the phase is changed next time, to cause the output voltage detected to be the target output voltage.

5. A voltage converter comprising:
a first set of switching devices including a first switch and a second switch connected in series on a first path connecting a first input terminal and a second input terminal;
a second set of switching devices including a third switch and a fourth switch connected in series on a second path connecting the first input terminal and the second input terminal, the second path being a different path from the first path;
a resonant capacitor connected between a first node located between the first switch and the second switch on the first path and a second node located between the third switch and the fourth switch on the second path;
a transformer including a primary winding and a secondary winding, the primary winding including one end connected to the resonant capacitor and a remaining end connected to the second node, the secondary winding being connected to a first output terminal and a second output terminal;
a detection circuit that detects an input voltage applied between the first input terminal and the second input terminal, an input current inputted to the first input terminal, an output voltage applied between the first output terminal and the second output terminal, and an output current outputted from the first output terminal; and
a control circuit,
wherein the control circuit:
changes: a phase between switching of the first set of switching devices and switching of the second set of switching devices; and an operating frequency of the first set of switching devices and the second set of switching devices to a phase reference value and an operating frequency reference value that are determined in advance in accordance with the input voltage detected, a target output voltage for the output voltage, and a target output current for the output current;
obtains a first indicator that is calculated from the input voltage, the input current, the output voltage, or the output current that is detected when the phase and the operating frequency are changed to the phase reference value and the operating frequency reference value;
retains, as reference values, the phase reference value, the operating frequency reference value, and the first indicator;
(i) changes the phase from the phase reference value by a certain amount after changing the phase and the operating frequency to the phase reference value and the operating frequency reference value;
(ii) changes the operating frequency after changing the phase from the phase reference value by the certain amount to cause the output voltage detected to be the target output voltage;
(iii) obtains a second indicator that is calculated from the input voltage, the input current, the output voltage, or the output current that is detected when the output voltage detected becomes the target output voltage;
(iv) updates the reference values in accordance with a result of comparing the first indicator and the second indicator; and
repeatedly performs each of processes from (i) to (iv).

6. The voltage converter according to claim 5,
wherein the voltage converter comprises a memory that stores a data table in which a combination of the input voltage, the target output voltage, and the target output current is associated with a combination of the phase reference value and the operating frequency reference value, and
the control circuit determines the phase reference value and the operating frequency reference value using the data table.

7. The voltage converter according to claim 5,
wherein each of the first indicator and the second indicator is efficiency, operating frequency, current that flows through the first to fourth switches at turn-off, voltage applied to the first to fourth switches at turn-on, output ripple voltage, or noise level.

8. The voltage converter according to claim 5,
wherein the control circuit performs Proportional Integral (PI) control of the phase and the operating frequency in accordance with the result of comparing the first indicator and the second indicator.

9. The voltage converter according to claim 5,
wherein the control circuit skips performing the process of (ii) when the output voltage detected becomes the target output voltage after changing the phase from the phase reference value by the certain amount in the process of (i).

10. A control method for controlling a voltage converter,
wherein the voltage converter includes:
a first set of switching devices including a first switch and a second switch connected in series on a first path connecting a first input terminal and a second input terminal;
a second set of switching devices including a third switch and a fourth switch connected in series on a second path connecting the first input terminal and the second input terminal, the second path being a different path from the first path;
a resonant capacitor connected between a first node located between the first switch and the second switch on the first path and a second node located between the third switch and the fourth switch on the second path;
a transformer including a primary winding and a secondary winding, the primary winding including one end connected to the resonant capacitor and a remaining end connected to the second node, the secondary winding being connected to a first output terminal and a second output terminal; and
a detection circuit that detects an input voltage applied between the first input terminal and the second input terminal, an input current inputted to the first input terminal, an output voltage applied between the first output terminal and the second output terminal, and an output current outputted from the first output terminal,
the control method comprising:
changing: a phase between switching of the first set of switching devices and switching of the second set of switching devices; and an operating frequency of the first set of switching devices and the second set of switching devices to a phase reference value and an operating frequency reference value that are determined in advance in accordance with the input voltage detected, a target output voltage for the output voltage, and a target output current for the output current;
obtaining a first indicator that is calculated from the input voltage, the input current, the output voltage, or the output current that is detected when the phase and the operating frequency are changed to the phase reference value and the operating frequency reference value;
retaining, as reference values, the phase reference value, the operating frequency reference value, and the first indicator;
(i) changing the phase from the phase reference value by a certain amount after the changing of the phase and the operating frequency to the phase reference value and the operating frequency reference value;
(ii) changing the operating frequency after the changing of the phase from the phase reference value by the certain amount to cause the output voltage detected to be the target output voltage;
(iii) obtaining a second indicator that is calculated from the input voltage, the input current, the output voltage, or the output current that is detected when the output voltage detected becomes the target output voltage;
(iv) updating the reference values in accordance with a result of comparing the first indicator and the second indicator; and
repeatedly performing each of processes from (i) to (iv).

11. A voltage converter comprising:
a first set of switching devices including a first switch and a second switch connected in series on a first path connecting a first input terminal and a second input terminal;
a second set of switching devices including a third switch and a fourth switch connected in series on a second path connecting the first input terminal and the second input terminal, the second path being a different path from the first path;
a resonant capacitor connected between a first node located between the first switch and the second switch on the first path and a second node located between the third switch and the fourth switch on the second path;
a transformer including a primary winding and a secondary winding, the primary winding including one end connected to the resonant capacitor and a remaining end connected to the second node, the secondary winding being connected to a first output terminal and a second output terminal;
a detection circuit that detects an input voltage applied between the first input terminal and the second input terminal, an input current inputted to the first input terminal, an output voltage applied between the first output terminal and the second output terminal, and an output current outputted from the first output terminal;
a memory that stores a data table in which a combination of the input voltage, the input current, the output voltage, and the output current and a combination of a phase target value and an operating frequency target value are associated for each target output voltage for the output voltage; and
a control circuit,
wherein the control circuit changes: a phase between switching of the first set of switching devices and switching of the second set of switching devices; and an operating frequency of the first set of switching devices and the second set of switching devices to the phase target value and the operating frequency target value that are obtained by comparing, with the data table, the input voltage, the input current, the output voltage, and the output current that have been detected.

12. A control method for controlling a voltage converter,
wherein the voltage converter includes:
a first set of switching devices including a first switch and a second switch connected in series on a first path connecting a first input terminal and a second input terminal;
a second set of switching devices including a third switch and a fourth switch connected in series on a second path connecting the first input terminal and the second input terminal, the second path being a different path from the first path;
a resonant capacitor connected between a first node located between the first switch and the second switch on the first path and a second node located between the third switch and the fourth switch on the second path;
a transformer including a primary winding and a secondary winding, the primary winding including one end connected to the resonant capacitor and a remaining end connected to the second node, the secondary winding being connected to a first output terminal and a second output terminal;
a detection circuit that detects an input voltage applied between the first input terminal and the second input terminal, an input current inputted to the first input terminal, an output voltage applied between the first output terminal and the second output terminal, and an output current outputted from the first output terminal; and
a memory that stores a data table in which a combination of the input voltage, the input current, the output voltage, and the output current and a combination of a phase target value and an operating frequency target value are associated for each target output voltage for the output voltage,
the control method comprising:
obtaining the input voltage, the input current, the output voltage, and the output current that have been detected; and
changing: a phase between switching of the first set of switching devices and switching of the second set of switching devices; and an operating frequency of the first set of switching devices and the second set of switching devices to the phase target value and the operating frequency target value that are obtained by comparing, with the data table, the input voltage, the input current, the output voltage, and the output current that have been detected.
